(19) United States
(12) Patent Application Publication
(10) Pub. No.: US 2016/0109156 A1
(43) Pub. Date: Apr. 21, 2016

(54) INTERNAL CONDENSER FOR HEAT PUMP WATER HEATER

(71) Applicant: A. O. Smith Corporation, Milwaukee, WI (US)

(72) Inventor: Jianmin Yin, Racine, WI (US)

(21) Appl. No.: 14/520,072

(22) Filed: Oct. 21, 2014

(51) Int. Cl. F24H 4/04; B23P 15/26; F24H 9/14; F24H 9/02

(52) U.S. Cl. CPC F24H 4/04; F24H 9/02; B23P 15/26; F24H 9/146

(57) ABSTRACT

An internal double wall condenser for a tank-type heat pump water heater. The condenser includes inlet and outlet sections designed for low heat transfer and a coil section designed for high heat transfer. The condenser includes first and second inner tubes that conduct refrigerant, and an outer tube surrounding the inner tubes. The outer tube has a circular cross-section in the inlet and outlet sections and a barbell cross-section in the coil section. The barbell cross-section includes first and second conduits that contain and are in heat transfer contact with the respective first and second inner tubes, and a connecting portion that interconnects the first and second conduits and increases the heat transfer surface. The barbell cross-section is made by deforming the outer condenser tube such that opposite walls are brought together between the two inner tubes.

### BACKGROUND

The present invention relates to a heat pump water heater with an internal condenser.

Tank-type heat pump water heaters (HPWH) with external condensers are known. In such known HPWH's, the condenser is wrapped around the outside of the water holding tank or used as an external heat exchanger. In such external wrap-around style condenser designs, ⅔ of the tank height from the bottom is typically covered by the condenser tubes, to ensure enough heat transfer surface area between the condenser and the tank.

A typical tank-type water heater includes a jacket surrounding the tank, and foam insulation in the space between the jacket and the tank. In a tank-type HPWH, the condenser tube is also in the space between the jacket and tank and occupies some of the space that the insulating foam would occupy if there were no condenser tube wound around the outer surface of the tank.

The tank of a tank-type water heater is usually cylindrical and is characterized by a diameter and a height. The ratio of diameter to height (D/H) is an important design consideration for the water heater. Typically heat pump water heaters have diameters between 16-22 inches and volumes between 50-80 gallons. While tank-type HPWHs with external condensers work well when the D/H ratio is relatively low, such HPWHs often become less efficient as the D/H ratio increases. For example, when D/H is greater than or equal to about 0.5, it is often difficult to reliably heat the water in the tank with an external condenser or the external condenser must be made so large that it becomes too costly. When an increase in tank diameter contributes to an increase in the D/H ratio, water close to the longitudinal axis of the tank is further away from the tank wall and more difficult to heat with a heat source at the tank wall. Additionally, for a given tank volume there is a practical lower limit for tank height arising from the available external surface area of the tank to which the external condenser can be mounted.

### SUMMARY

In one embodiment, the invention provides a water heater comprising: a water tank for storing water to be heated; and a heat pump system including an evaporator, a compressor, an expansion device, and a condenser for moving a refrigerant through a refrigerant cycle that includes an exchange of heat from the refrigerant in the condenser to water in the tank; wherein the condenser comprises an outer tube and first and second inner tubes within the outer tube; wherein all refrigerant in the condenser is within the first and second inner tubes; and wherein at least a portion of the condenser is positioned within the tank, the outer tube is in direct contact with water in the tank, and the first and second inner tubes are not in direct contact with water in the tank.

In some constructions, the heat pump includes a refrigerant splitter communicating between the compressor and the condenser; the refrigerant splitter receives a single flow of refrigerant from the compressor and splits the single flow of refrigerant into first and second parallel flows of refrigerant; and the first and second inner tubes communicate with the refrigerant splitter to receive the respective first and second flows of refrigerant.

In some constructions, the condenser includes an inlet section, a coil section, and an outlet section; the coil section and at least a portion of the inlet section and outlet section are in the water tank; the coil section of the outer tube has a cross section including first and second conduits and a connecting portion interconnecting the first and second conduits; and the first and second inner tubes are within the respective first and second conduits. In some constructions, the connecting portion comprises opposite wall portions of the outer tube adjacent each other. In some constructions, the width of the connecting portion between the first and second conduits is 4-12 mm, and inner tube has outer diameters of 0.25±0.1 inches (0.635±0.25 cm). In some constructions, the first and second conduits are in physical contact with at least half an outer surface of the respective first and second inner tubes to promote heat transfer. In some constructions, the first and second conduits are in physical contact with at least three quarters of an outer surface of the respective first and second inner tubes to promote heat transfer. In some constructions, the outer tube in the inlet and outlet sections of the condenser is shaped such that no pressurized contact arises between the outer tube and the first and second inner tubes to discourage heat transfer between the outer tube and the first and second inner tubes in the inlet and outlet sections of the condenser. In some constructions, the outer tube in the inlet and outlet sections of the condenser is circular in cross section. In some constructions, the coil section of the condenser is entirely in the bottom half of the water heater tank. In some constructions, the coil section of the condenser includes an upper portion at least partially in the upper half of the water tank, and a lower portion entirely in the bottom half of the water heater tank. In some constructions, the coil section includes first and second sections having different coil pitches. In some constructions, the coil section includes a first section and a second section that is at least partially nested within the first section. In some constructions, the coil section includes a non-constant coil diameter. In some constructions, at least one of the inner tubes includes internal fins or groves to promote heat transfer. In some constructions, the condenser includes an inlet section extending through a bottom header of the tank, a coil section, and an outlet section extending through the bottom header.

The invention also provides a method for manufacturing a double-walled tube, the method comprising: (a) providing an outer tube with a circular cross section and an initial outer tube diameter; (b) deforming a portion of the outer tube into an oval cross section; (c) inserting first and second inner tubes into the outer tube having a deformed portion; and (d) further deforming the deformed portion of the outer tube into first and second conduits and a connecting portion between the first and second conduits, such that the first and second inner tubes are trapped within the respective first and second conduits.

In some constructions, step (d) includes bringing opposite portions of a wall of the outer tube adjacent each other. In some constructions, step (d) includes bringing opposite portions of a wall of the outer tube into physical contact with each other. In some constructions, step (d) includes placing the first and second conduits in physical contact with at least half an outer surface of the respective first and second inner tubes to promote heat transfer. In some constructions, step (d) includes placing the first and second conduits in physical contact with at least three quarters of an outer surface of the respective first and second inner tubes to promote heat transfer. In some constructions, the outer tube of step (a) includes first and second ends and a middle section between the first and second ends; wherein step (d) includes deforming the middle section; and wherein steps (b), (c), and (d) include maintaining the initial outer tube diameter at the first and second ends. In some constructions the method further comprises forming the further deformed portion into a coil.

Other aspects of the invention will become apparent by consideration of the detailed description and accompanying drawings.

### BRIEF DESCRIPTION OF THE DRAWINGS

FIG. 1 is a perspective view of a tank-type heat pump water heater (HPWH) including an internal double wall condenser according to the present invention.

FIG. 2 is a perspective view of the condenser portion of the heat pump.

FIG. 3 is a cross-section of the condenser taken along line 3-3 in FIG. 2.

FIG. 4 is an enlarged view of the portion of the condenser within circle 4-4 in FIG. 3.

FIG. 5 is a cross-section taken along line 5-5 in FIG. 2.

FIG. 6 is a cross-section similar to FIG. 5, but including finned inner tubes and a web between the inner tubes.

FIG. 7 is a cross-section of the coil section of the condenser construction of FIG. 6.

FIG. 8 is a cross-section of the coil section of the outer tube in a first step of manufacturing the condenser.

FIG. 9 is a cross-section of the coil section of the outer tube and inner tubes in a second step of manufacturing the condenser.

FIG. 10 is a cross-section of the coil section of the outer tube and inner tubes in a third step of manufacturing the condenser.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

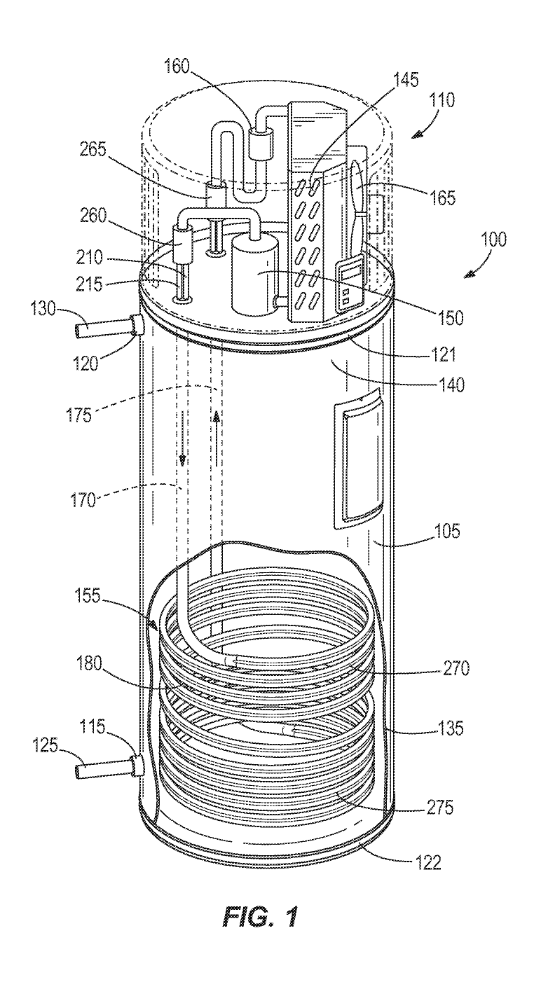

FIG. 1 illustrates a tank-type heat pump water heater (HPWH) 100 that includes a water tank 105 for storing water to be heated and a heat pump 110 for heating the water. The tank 105 includes a cold water inlet spud 115 and a hot water outlet spud 120. The tank 105 also includes a top header 121 and a bottom header 122. A cold water supply pipe 125 communicates through the cold water inlet spud 115 between the tank 105 and a water utility or other water source. The supply of cold water is under pressure. A hot water supply pipe 130 communicates through the hot water outlet spud 120 between the tank 105 and a faucet, shower, dishwasher or other plumbing fixture where hot water is put to use. FIG. 1 illustrates the cold water inlet spud 115 in a bottom portion 135 in a bottom half of the tank 105 and the hot water outlet spud 120 in a top portion 140 in a top half of the tank 105, but in other configurations one or both of the spuds 115, 120 could be on the top header 121 or bottom header 122. A dip tube may be used to strategically introduce cold water in a desired portion of the tank 105 or to draw hot water from the tank 105.

The heat pump 110 is illustrated semi-schematically in FIG. 1; not all details of the components are necessarily illustrated. Some components such as motors and power lines are not illustrated for the sake of clarity in the drawing. The main components of the heat pump 110 are an evaporator 145, a compressor 150, an expansion device 160, and a condenser 155. Refrigerant moves through these main components in a refrigerant cycle that absorbs heat from the ambient air around the HPWH 100 and transfers the heat to water in the tank 105. A fan 165 moves relatively warm ambient air over the evaporator 145, which may be, for example, a fin-tube heat exchanger with refrigerant inside the tubes. The fan 165 may be driven by an electric motor, for example. The refrigerant is introduced to the evaporator 145 as cool two-phase (liquid mixed with vapor) refrigerant. The relatively warm ambient air warms the cool two-phase refrigerant in the evaporator 145 to convert the liquid portion into vapor refrigerant, such that warm all-vapor refrigerant flows out of the evaporator 145. The ambient air is cooled as a consequence of transferring heat to the refrigerant in the evaporator 145, and moves out of the evaporator 145 under the influence of the fan 165. The cool air can be ducted to a space where cool air is desired.

The warm vapor refrigerant moves from the evaporator 145 to the compressor 150 under the influence of the suction of the compressor 150, and carries the heat it absorbed from the ambient air in the evaporator 145. The compressor 150 may also be driven by an electric motor, for example. The compressor 150 compresses the warm vapor refrigerant, which raises the refrigerant's temperature and pressure to produce superheated vapor refrigerant. The superheated vapor refrigerant moves through the condenser 155 and causes the condenser 155 to become hot. The hot condenser 155 heats water in the tank 105 to produce hot water. As heat is exchanged from the superheated vapor refrigerant to the water through the condenser 155, the superheated refrigerant cools. As the superheated refrigerant cools, liquid droplets form. More and more liquid droplets form as the refrigerant moves along the condenser tube and cools further. Eventually, the refrigerant becomes all liquid with some subcooling at the end of the condenser 155. The subcooled liquid refrigerant flows through the expansion device 160, resulting in the two-phase cool refrigerant mentioned above. The expansion device 160 may be, for example a TXV (thermal expansion valve), EXV (electric expansion valve), capillary tube, or some kind of combination of capillary tube and other devices such as TXV. The two-phase cool refrigerant flows to the evaporator 145 and the cycle repeats.

At least a portion of the condenser 155 is submerged within the water in the tank 105. The submerged portion must have a double-walled configuration as required by relevant regulations. The condenser 155 includes a vertical inlet section 170, a vertical outlet section 175, and a coil section 180 communicating between the inlet and outlet sections 170, 175. The inlet section 170 of the condenser 155 receives the superheated vapor refrigerant from the compressor 150 and the outlet section 175 of the condenser 155 delivers the subcooled liquid refrigerant to the expansion device 160. Most of the heat exchange between the refrigerant and the water occurs along the coil section 180.

Natural convection causes warmer water in the tank 105 to rise to the top portion 140 of the tank 105 and cooler water to sink to the bottom portion 135 of the tank 105. The condenser 155 is designed to minimize heat transfer in the inlet and outlet sections 170, 175, because the inlet and outlet sections 170, 175 extend vertically through the top portion 140 of the tank 105 where the hottest water resides. The condenser 155 is also designed to maximize heat transfer in the coil section 180, which is positioned and configured in the tank 105 to strategically produce a maximum volume of hot water.

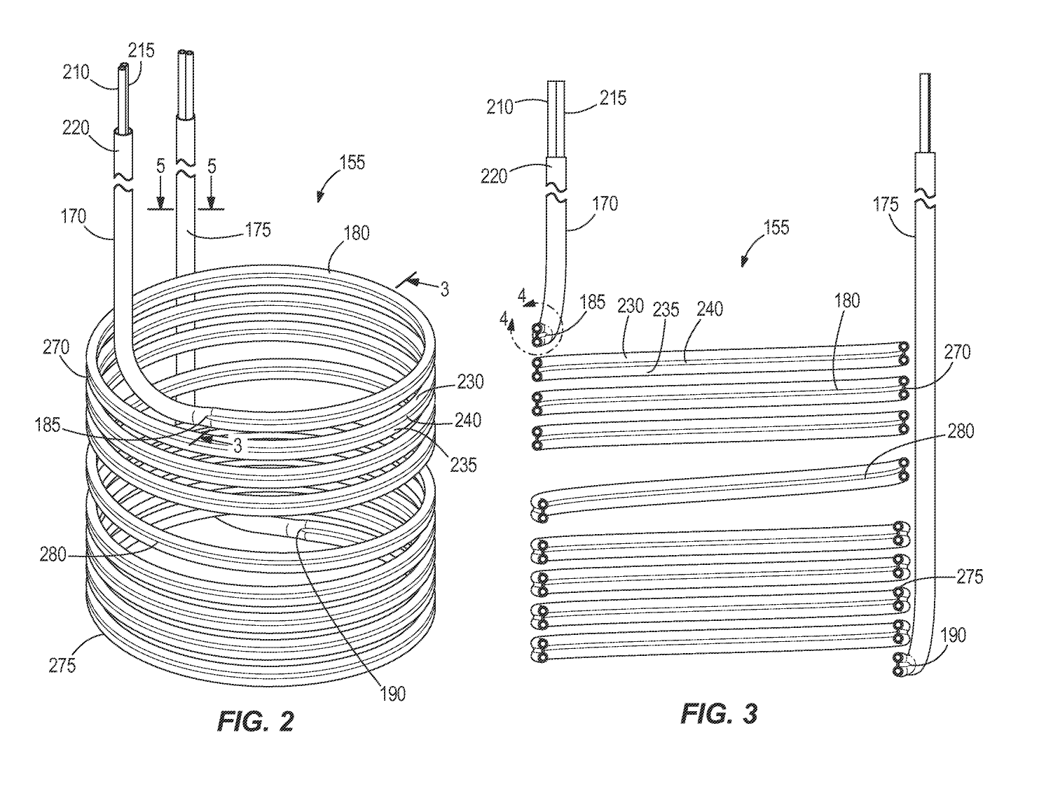

With reference to FIGS. 2 and 3, the condenser 155 includes an inlet transition 185 between the coil section 180 and the inlet section 170 and an outlet transition 190 between the coil section 180 the outlet section 175. The inlet and outlet sections 170, 175 include first and second inner tubes 210, 215 within a circular cross-section outer tube 220. In the coil section 180, the outer tube 220 includes first and second conduits 230, 235 connected by a flat connecting portion 240, much like a barbell shape in cross-section, as will be discussed further below. The inlet transition 185 changes the outer tube 220 shape from the circular cross section at the inlet section 170 to the barbell cross-section at the coil section 180, and the outlet transition 190 changes the outer tube 220 shape from the barbell cross-section back to the circular cross section at the outlet section 175.

Referring again to FIG. 1, in the illustrated construction the coil section 180 and at least a portion of each of the inlet section 170 and outlet section 175 are in the tank 105 and submerged in the water in the tank 105. The illustrated inlet and outlet sections 170, 175 pass through the top header 121. In other constructions, the condenser 155 can pass through the bottom header 122. If the condenser 155 extends into the tank 105 through the bottom header 122, the inlet section 170 would include an external portion that runs down the outside of the tank 105 to the bottom header 122, and an internal portion extending up to the top of the coil section 180. At the bottom of the coil section 180, the outlet section 175 can be ported out the bottom header 122 and along the outside of the tank 105 up to the expansion device 160. Because a double wall configuration is only required inside the tank 105, there would be no need for the outer tube 220 for the condenser portions outside the tank 105. The external portions of the inlet section 170 and outlet section 175 could simply include the inner tubes 210, 215 without the outer tube 220.

Outside of the condenser 155 (e.g., in the expansion device 160, evaporator 145, and compressor 150), the refrigerant flows in a single, undivided flow path. The refrigerant is separated into two parallel flows (one for each of the first and second inner tubes 210, 215) prior to entering the condenser 155 and is combined into a single, undivided flow when flowing out of the condenser 155. For those purposes, as illustrated in FIG. 1, the heat pump 110 includes a refrigerant splitter 260 communicating between the compressor 150 and the condenser inlet section 170 and a combiner 265 communicating between the condenser outlet section 175 and the expansion device 160. The refrigerant splitter 260 receives a single flow of refrigerant from the compressor 150 and splits the single flow of refrigerant into first and second parallel flows of refrigerant that are received by the respective first and second inner tubes 210, 215. The splitter 260 allows the use of smaller diameter inner tubes 210, 215, which is good for heat transfer, occupies less volume in the tank (resulting in more water volume), with smaller refrigerant side pressure drops, and reduces refrigerant charge. The combiner 265 merges the parallel flows of subcooled liquid refrigerant from the first and second inner tubes 210, 215 at the condenser outlet section 175 into a single flow of subcooled liquid refrigerant to the expansion device 160.

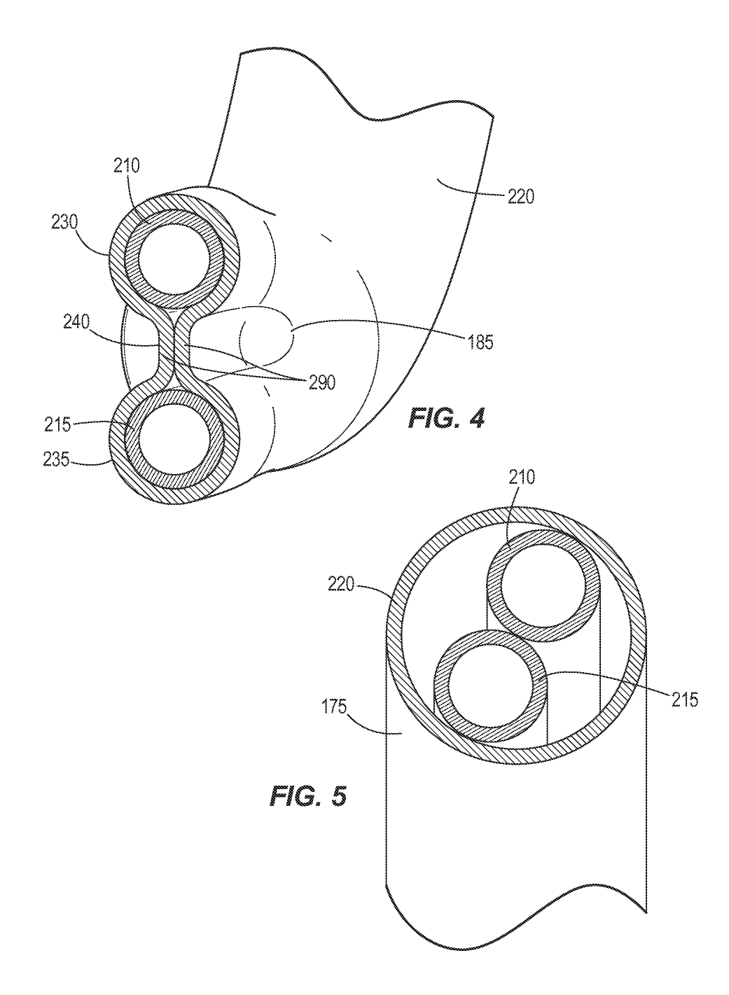

FIGS. 4 and 5 illustrate cross-sections of the condenser 155. All refrigerant in the condenser 155 is within the first and second inner tubes 210, 215. The outer tube 220 provides a second wall surrounding both the first and second inner tubes 210, 215. The outer tube 220 is in direct contact with water in the tank 105, and the first and second inner tubes 210, 215 are not in direct contact with water in the tank 105. Suitable materials for the outer tube 220 include coated steel, stainless steel, copper, coated aluminum, and high conductivity plastic or polymer materials. Suitable materials for the inner tubes 210, 215 include steel, stainless steel, aluminum, and copper. The outer tube 220 and inner tubes 210, 215 may be made by extrusion or another suitable method.

With reference to FIG. 5, the outer tube 220 has a circular cross-section in the outlet section 175, and there is little contact between the outer tube 220 and the first and second inner tubes 210, 215. The configuration in the inlet section 170 is identical to that illustrated in FIG. 5. In one configuration of the inlet and outlet sections 170, 175, the outer tube 220 has an inner diameter of 0.652±0.2 inches (1.66±0.51 cm) and the inner tubes 210, 215 have outer diameters of 0.25±0.1 inches (0.635±0.25 cm). Ideally, there will be no contact between the inner tubes 210, 215 and the outer tube 220 in the inlet and outlet sections 170, 175. To the extent there is contact in the inlet and outlet sections 170, 175, it is preferable that there be very little or no pressurized contact and that the contact involve less than 10% of the surface area of the inner wall of the outer tube 220.

Because there is little or no contact or pressurized contact between the outer tube 220 and the first and second inner tubes 210, 215, heat transfer from the inner tubes 210, 215 to the outer tube 220 is very low. The outer tube 220 is thus shaped to discourage heat transfer between the outer tube 220 and the first and second inner tubes 210, 215 in the inlet and outlet sections 170, 175 of the condenser 155. The inlet and outlet sections 170, 175 extend through the hottest water in the tank 105, in the top portion 140 of the tank 105 and it is undesirable to add heat (via the hot inlet section 170 of the condenser 155) or draw heat (via the cool outlet section 175 of the condenser 155) to or from the hot water in the top portion 140 of the tank 105.

With reference to FIG. 4, and as mentioned briefly above, in the coil section 180 the outer tube 220 includes first and second conduits 230, 235 connected by a flat connecting portion 240, much like a barbell shape in cross-section. The first and second inner tubes 210, 215 are within the respective first and second conduits 230, 235. There is a large amount of contact between the outer tube 220 and the first and second inner tubes 210, 215 in the coil section 180. In one configuration, about 75-95% of the outer surface area of each inner tube 210, 215 is in contact with the inner wall of the outer tube 220. In some configurations, about three quarters (75%) of the outer surface area of the inner tubes 210, 215 is in contact with the inner wall of the outer tube 220. With reference to FIG. 10, the arc length of contact 250 between each inner tube 210, 215 and the inner wall of the conduit sections 230, 235 may be 270°-350°.

The width of the connecting portion 240 relative to the size of the conduits 230, 235 is also designed to improve heat transfer. With reference to FIG. 10, the width 245 of the connecting portion 240 may be about 70-200% of the outer diameter of each conduit 230, 235 or 15-50% of the arc length of contact 250. In one configuration, the width of the connecting portion 240 between the first and second conduits 230, 235 may be between 4 to 12 mm. When properly sized relative to the conduits 230, 235, inner tubes 210, 215, and arc length of contact 250, the connecting portion 240 provides a heat transfer surface across its entire width as it is heated by conduction through the outer tube wall 220 from both sides by the superheated refrigerant in the respective inner tubes 210, 215 and conduits 230, 235. Because there is a large amount of contact between the outer tube 220 and the first and second inner tubes 210, 215 and because the connecting portion 240 is configured to be an effective heat transfer surface, heat transfer from the inner tubes 210, 215 to the outer tube 220 is very high in the coil section 180.

The coil section 180 extends through the coolest water in the tank 105, in the bottom portion 135 of the tank 105, where it is desirable to add heat to the water. The position and shape of the coil section 180 can be modified to achieve a desired water heater effect. For example, the coil section 180 of the condenser 155 may be entirely in the bottom portion 135 or bottom half of the water heater tank 105 to focus the condenser 155 heat entirely on the coldest water in the tank 105. In the illustrated example (see FIGS. 2 and 3), the coil section 180 of the condenser 155 may include an upper portion 270 at least partially in the top half or top portion 140 of the water tank 105 to provide some heating to water in the top half or top portion 140, and a lower portion 275 entirely in the bottom half or bottom portion 135 of the water heater tank 105. The upper and lower portions 270, 275 of the coil section 180 are connected with a wide-pitch length 280 of the coil section 180.

In other constructions, there may be more than two sections of coil 180, each connected by a wide-pitch length 280. The coil section 180 may include first and second sections having different coil pitches. The coil section 180 may include a section that is at least partially nested within the another section of the coil section 180 so there are effectively two coils in a portion of the tank 105 where the water volume needs more heat transfer surface. For example, in a water heater having a large diameter or a large D/H ratio owing to a proportionally large diameter, an inner coil of the coil section 180 would ensure that water close to the longitudinal axis of the tank 105 would be heated. The present invention therefore enables a heat pump water heater to effectively heat water in tanks of typical size, and also enables a heat pump water heater having tanks of a relatively large D/H ratio (e.g., a ratio great than or equal to about 0.5) due to the tank having an unusually large diameter or being unusually short for a given volume.

The coil section 180 may include a non-constant coil diameter, by which the diameter of the coil section 180 increases or decreases. The coil diameter may increase or decrease at strategically chosen portions of the tank 105, may increase or decrease linearly or as a function of the longitudinal position (i.e., position along the longitudinal axis) within the tank 105, or may be hourglass shaped just to name a few potential configurations and shapes.

The cross-sectional shape of the coil section 180 can also be varied. In one exemplary configuration illustrated in FIG. 4, the connecting portion 240 comprises opposite wall portions 290 of the outer tube 220 adjacent each other. The connecting portion 240 provides extended surface area between the two inner tubes 210, 215. These opposite wall portions 290 are illustrated as contacting each other to maximize the wrap-around of the conduit portions 230, 235 on the inner tubes 210, 215. Placing the opposite wall portions 290 in contact with each other in the connecting portion 240 can also enhance or even out overall heat transfer for the condenser coil 180 because heat is able to move efficiently along the entire outer tube 220 and across the outer tube 220 between the opposite walls 290. In a variation of this cross-section, there may be a small gap between the opposite wall portions 290.

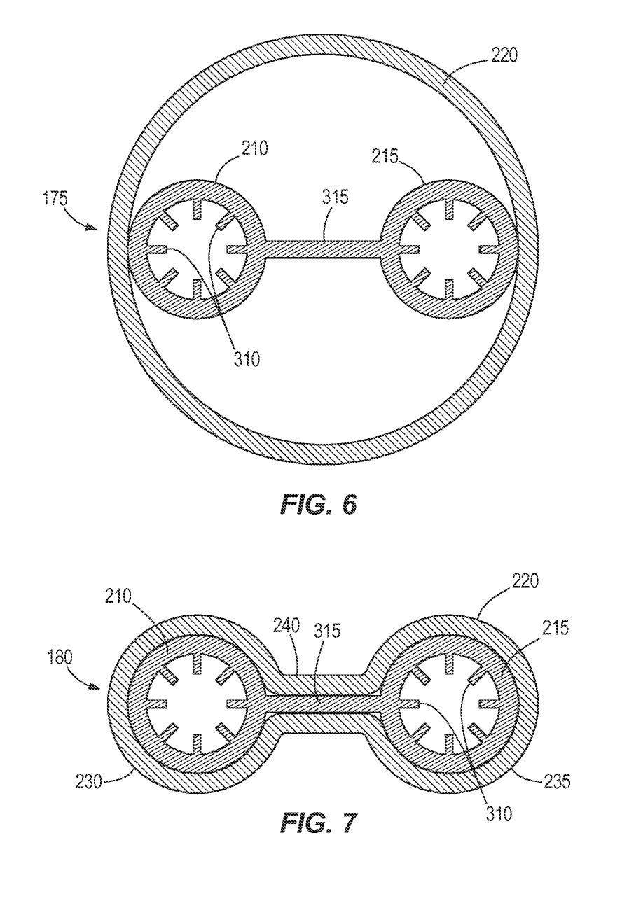

FIGS. 6 and 7 illustrate another construction of the condenser 155, in which the inner tubes 210, 215 are extruded and include internal fins 310 or groves and may include a web 315 interconnecting the inner tubes 210, 215. Such features (fins 310, grooves, web 315) can be provided independent of each other in other constructions. The invention can also be practiced with more than two inner tubes, in which case the outer tube 220 would be shaped into more conduits to accommodate all the inner tubes, and flattened between all the conduits. The extruded internal tubes 210, 215 could also be provided with non-circular cross-sections.

With reference again to FIG. 1, the superheated vapor refrigerant is split into parallel flow paths by the splitter 260 and enters the circular cross-section condenser inlet section 170. The superheated vapor refrigerant in the inlet section 170 enters the top of the coil section 180, where the condenser 155 is flattened into the barbell shape to increase the water side heat transfer areas. The superheated vapor refrigerant moves downward through the condenser coil section 180, giving up heat to the water in the tank 105 along the way and toward the bottom of the coil 180 becoming subcooled liquid refrigerant. From the bottom of the coil 180, the subcooled liquid refrigerant enters the circular outlet section 175 and moves up through the tank 105 to the combiner 265 where the parallel flows of subcooled liquid refrigerant are merged and passed along to the expansion device 160. The superheated vapor refrigerant is introduced at the top of the coil section 180 rather than the bottom to follow the heat gradient of the water in the tank 105. The hottest refrigerant transfers heat to the warm water in the middle of the tank 105 and the cooler refrigerant lower in the coil 180 transfers heat to progressively cooler water in the tank 105. As noted above, heat transfer in the inlet and outlet sections 170, 175 of the condenser 155 is reduced by the circular cross-section of the outer tube 220 and relatively small surface area contact between the outer tube 220 and the inner tubes 210, 215 in those sections. Heat transfer could be further reduced if these sections were coated with a material that resisted heat transfer.

The condenser 155 is manufactured in several steps, illustrated in FIGS. 8-10. The outer tube 220 is provided, having a circular cross-section of an initial outer diameter 350. The length of the outer tube 220 is the length of the condenser 155, including the inlet section 170, the outlet section 175, and a middle portion that will be transformed into the coil section 180.

In FIG. 8, the middle portion of the outer tube 220 is first deflected into an oval cross-section, leaving the ends on opposite sides of the middle portion (i.e., the inlet section 170 and outlet section 180) in circular cross-section. After deflecting the middle portion into an oval cross-section, the outer tube 220 may be referred to as an outer tube 220 having a deformed portion. The oval cross-section is not necessarily elliptical but may be elliptical. The initial outer tube diameter 350 is maintained at the first and second ends (i.e., the inlet section 170 and outlet section 180) on either side of the middle portion.

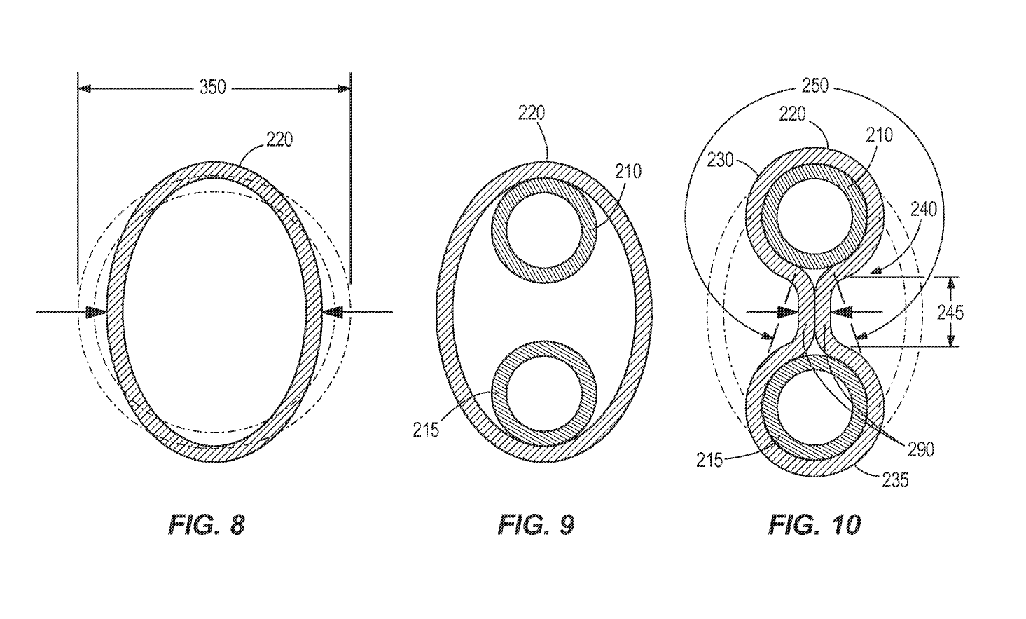

In FIG. 9, the two inner tubes 210, 215 are inserted into the outer tube 220 having a deformed portion. The oval middle portion keeps the inner tubes 210, 215 side-by-side and not twisted around each other. Depending on the outer tube material, thermal paste could be applied to the inner tubes before they are inserted into the outer tube for the coiled section.

In FIG. 10, with the first and second inner tubes 210, 215 inside the outer tube 220, the middle portion of the outer tube 220 is further deformed into the barbell shape cross-section (i.e., a cross-sectional shape having the first and second conduits 230, 235 and the connecting portion 240 between the first and second conduits 230, 235). The first and second inner tubes 210, 215 are trapped within the respective first and second conduits 230, 235. The initial outer tube diameter 350 is still maintained at the first and second ends (i.e., the inlet section 170 and outlet section 180) on either side of the middle portion.

As can be seen in FIG. 10, when the middle portion is further deformed into the barbell shape, the opposite walls 290 of the outer tube 220 are brought parallel each other and placed into physical contact with each other in the connecting portion 240. As the middle portion is further deformed into the barbell shape, the first and second conduits 230, 235 are placed into physical contact with a substantial portion of the outer surface of the respective first and second inner tubes 210, 215 to promote heat transfer. While further deforming the middle portion 240 into the barbell cross-section shape, the middle portion 240 can also be bent into the shape of a coil to form the coil section 180 of the condenser 155. Conductive thermal paste could be applied during the manufacturing process to the outside surface of the inner tubes 210, 215 to promote better heat transfer between the inner tubes 210, 215 and the outer tube 220 in the coil section 180 or protect the outer tube from rust.

With the condenser 155 formed, the water heater 100 can be assembled. The condenser 155 is inserted into the water heater tank 105. The tank top header 121 is secured to the tank 105 with the condenser inlet and outlet sections 170, 175 extending through the tank top header 121 and secured to the tank top header 121 by welding, compression fittings, or any other suitable means. The tank top header 121 could be a plus header or a minus header. With a plus header, the top header 121 can be attached to the tank 105 first, then the condenser 155 will be attached to the top header 121. With a minus header, the condenser 155 can be attached to the top header 121 first, then pushed into the tank 105. As noted above, the condenser 155 can also pass into and out of the tank 105 through the tank bottom header 122, and the same assembly considerations noted for a top header 121 configuration apply to a bottom header 122 configuration.

The present invention positions the condenser of a tank-type HPWH inside the tank 105. With the coil section 180 inside the tank 105, the water does not have to be heated through the tank wall. The coil section 180 can be fully submerged in the water in that tank 105, which inherently increases the heat transfer surface between the coil section 180 and the water to be heated, compared to an external condenser which necessarily has a portion of its potential heat transfer surface area facing away from the tank 105. Also, because the coil section 180 is inside the tank 105, the space between the jacket and the tank 105 that would have been occupied by the condenser 155 can be occupied by additional foam insulation to reduce standby heat loss.

HPWHs often are designed with the condenser 155 on the outside of the water tank 105 to avoid lowering the storage volume of the tank 105. The present invention, however, improves the heat transfer efficiency of the condenser 155 in the coil section 180 so that the condenser 155 can be made shorter than ever before and reduce the volume of water displaced by the condenser 155. The heat transfer efficiency is improved by the present invention by splitting the refrigerant flow into parallel flows so that smaller diameter inner tubes 210, 215 and external tube 220 can be used, and by employing the connecting portion 240 that is also a heat transfer surface. Smaller diameter inner tubes 210, 215 can help reduce the refrigerant charge amount, and can lower refrigerant side pressure drops for the condenser 155. The unique transitions 185, 190 between the coil section 180 and the inlet and outlet sections 170, 175 severely reduce heat transfer between the condenser 155 and the water in the tank 105 on either side of the coil 180. The internal condenser 155 of the present invention also eliminates the need for external heat conductive paste, which is used improve the heat transfer between external heat exchangers and the outer surface of the tank wall.

Simulation shows this design could cut the tube length to ⅓ of the external design, could be easier to manufacturing and assembly, and potential to lower cost. Because of the manufacturing flexibility (i.e., different portions of the outer tube 220 can be flattened or left round), the present invention can be used for a high performance HPWH with more coil turns; or a lower cost HPWH having fewer coil turns; or a HPWH in a larger diameter tank.

Thus, the invention provides, among other things, a HPWH having an internal double wall condenser in which the coil section includes parallel flow paths for superheated refrigerant and a joining section between the parallel paths to promote heat transfer. Various features and advantages of the invention are set forth in the following claims.

What is claimed is:

1. A water heater comprising:
a water tank for storing water to be heated; and
a heat pump system including an evaporator, a compressor, an expansion device, and a condenser for moving a refrigerant through a refrigerant cycle that includes an exchange of heat from the refrigerant in the condenser to water in the tank;
wherein the condenser comprises an outer tube and first and second inner tubes within the outer tube;
wherein all refrigerant in the condenser is within the first and second inner tubes; and
wherein at least a portion of the condenser is positioned within the tank, the outer tube is in direct contact with water in the tank, and the first and second inner tubes are not in direct contact with water in the tank.

2. The water heater of claim 1, wherein: the heat pump includes a refrigerant splitter communicating between the compressor and the condenser; the refrigerant splitter receives a single flow of refrigerant from the compressor and splits the single flow of refrigerant into first and second parallel flows of refrigerant; and the first and second inner tubes communicate with the refrigerant splitter to receive the respective first and second flows of refrigerant.

3. The water heater of claim 1, wherein: the condenser includes an inlet section, a coil section, and an outlet section; the coil section and at least a portion of the inlet section and outlet section are in the water tank; the coil section of the outer tube has a cross section including first and second conduits and a connecting portion interconnecting the first and second conduits; and the first and second inner tubes are within the respective first and second conduits.

4. The water heater of claim 3, wherein the connecting portion comprises opposite wall portions of the outer tube adjacent each other.

5. The water heater of claim 3, wherein the width of the connecting portion between the first and second conduits is 4-12 mm, and inner tube has outer diameters of 0.25±0.1 inches (0.635±0.25 cm).

6. The water heater of claim 3, wherein the first and second conduits are in physical contact with at least half an outer surface of the respective first and second inner tubes to promote heat transfer.

7. The water heater of claim 3, wherein the first and second conduits are in physical contact with at least three quarters of an outer surface of the respective first and second inner tubes to promote heat transfer.

8. The water heater of claim 3, wherein less than 10% of the surface area of the outer tube in the inlet and outlet sections of the condenser contacts the first and second inner tubes.

9. The water heater of claim 3, wherein the outer tube in the inlet and outlet sections of the condenser is circular in cross section.

10. The water heater of claim 3, wherein the coil section of the condenser is entirely in the bottom half of the water heater tank.

11. The water heater of claim 3, wherein the coil section of the condenser includes an upper portion at least partially in the upper half of the water tank, and a lower portion entirely in the bottom half of the water heater tank.

12. The water heater of claim 3, wherein the coil section includes first and second sections having different coil pitches.

13. The water heater of claim 3, wherein the coil section includes a first section and a second section that is at least partially nested within the first section.

14. The water heater of claim 3, wherein the coil section includes a non-constant coil diameter.

15. The water heater of claim 1, wherein at least one of the inner tubes includes internal fins or groves to promote heat transfer.

16. The water heater of claim 1, wherein: the condenser includes an inlet section extending through a bottom header of the tank, a coil section, and an outlet section extending through the bottom header.

17. A method for manufacturing a double-walled tube, the method comprising:
(a) providing an outer tube with a circular cross section and an initial outer tube diameter;
(b) deforming a portion of the outer tube into an oval cross section;
(c) inserting first and second inner tubes into the outer tube having a deformed portion; and
(d) further deforming the deformed portion of the outer tube into first and second conduits and a connecting portion between the first and second conduits, such that the first and second inner tubes are trapped within the respective first and second conduits.

18. The method of claim 17, wherein step (d) includes bringing opposite portions of a wall of the outer tube adjacent each other.

19. The method of claim 17, wherein step (d) includes bringing opposite portions of a wall of the outer tube into physical contact with each other.

20. The method of claim 17, wherein step (d) includes placing the first and second conduits in physical contact with at least half an outer surface of the respective first and second inner tubes to promote heat transfer.

21. The method of claim 17, wherein step (d) includes placing the first and second conduits in physical contact with at least three quarters of an outer surface of the respective first and second inner tubes to promote heat transfer.

22. The method of claim 17, wherein the outer tube of step (a) includes first and second ends and a middle section between the first and second ends; wherein step (d) includes deforming the middle section; and wherein steps (b), (c), and (d) include maintaining the initial outer tube diameter at the first and second ends.

23. The method of claim 17, further comprising: forming the further deformed portion into a coil.
